(19) United States
(12) Patent Application Publication
(10) Pub. No.: US 2019/0367327 A1
(43) Pub. Date: Dec. 5, 2019

(54) ELEVATOR GUIDE RAIL MOUNTING ARRANGEMENT AND METHOD FOR MOUNTING AN ELEVATOR GUIDE RAIL

(71) Applicant: Kone Corporation, Helsinki (FI)

(72) Inventors: Toni KALLIO, Helsinki (FI); Jukka NORJA, Helsinki (FI); Henri KOKKO, Helsinki (FI); Tapio SIIRONEN, Helsinki (FI); Sami RAIHA, Helsinki (FI)

(73) Assignee: Kone Corporation, Helsinki (FI)

(21) Appl. No.: 16/382,359

(22) Filed: Apr. 12, 2019

(30) Foreign Application Priority Data
May 29, 2018 (EP) 18174846.8

(51) Int. Cl. B66B 7/02

(52) U.S. Cl. CPC B66B 7/024; B66B 7/026

(57) ABSTRACT

An elevator guide rail mounting arrangement and a method for mounting an elevator guide rail using said elevator guide rail mounting arrangement. The arrangement comprises a plurality of support brackets fixed to an elevator shaft wall and a pair of spring-like fixing clips attached to each of the support. Each fixing clip comprises a first arm being fixed to the support bracket and a second arm bearing and pressing against a lateral foot flange of the guide rail. The arrangement comprises pairs of first fixing clips, which are arranged to provide a frictional holding force to resist the movement of the first fixing clips in relation to the guide rail in the vertical direction, and at least a pair of second fixing clips, which are arranged to allow movement of the second fixing clips in relation of the guide rail in the vertical direction. In the method the guide rail is mounted to the support brackets by pairs of first fixing clips and by at least a pair of the second fixing clips. The number and relative positions of the pairs of first and second fixing clips is selected on the basis of shrinkage amount of the shaft wall.

This application claims priority to European Patent Application No. EP18174846.8 filed on May 29, 2018, the entire contents of which are incorporated herein by reference.

### FIELD OF THE INVENTION

The present invention relates to an elevator guide rail mounting arrangement. Further, the present invention relates to a method for mounting an elevator guide rail using the elevator guide rail mounting arrangement.

### BACKGROUND OF THE INVENTION

Typically an elevator guide rail mounting arrangement comprises a plurality of support brackets fixed to an elevator shaft wall. The support brackets are spaced from each other vertically along the length of a guide rail. A pair of spring-like fixing clips is attached to each of the support brackets for supporting the guide rail to prevent movement of the guide rail in lateral direction. The fixing clips are arranged on both sides of the guide rail. The fixing clip comprises a first arm being fixed to the support bracket and a second arm bearing and pressing against a lateral foot flange of the guide rail. The fixing clips provide a frictional holding force to resist the movement of the guide rail in horizontal and vertical directions.

An elevator guide rail installation faces the problem that a building normally has certain shrinkage over the time so that the guide rails might buckle or bend when these are immovably fixed in the fixing clips. Sliding fixing clips which enable the movement of the support brackets in relation to the guide rail have been developed and are known e.g. from JP 2010179993A and EP 3085655 B1.

A problem with the known sliding fixing clips is that they do not allow to alter or to adjust the total guide rail line movement resistance in the vertical direction.

### OBJECTIVE OF THE INVENTION

The objective of the invention is to alleviate the disadvantages mentioned above.

### SUMMARY OF THE INVENTION

According to a first aspect, the present invention provides an elevator guide rail mounting arrangement comprising a plurality of support brackets fixed to an elevator shaft wall. The support brackets are spaced from each other vertically along the length of a guide rail. A pair of spring-like fixing clips is attached to each of the support brackets for supporting the guide rail to prevent movement of the guide rail in lateral direction. The fixing clips of the pair are arranged on both sides of the guide rail. Each fixing clip comprises a first arm being fixed to the support bracket and a second arm bearing and pressing against a lateral foot flange of the guide rail. The elevator guide rail mounting arrangement comprises pairs of first fixing clips which are arranged to provide a frictional holding force to resist the movement of the first fixing clips in relation to the guide rail in the vertical direction. According to the invention the elevator guide rail mounting arrangement comprises at least a pair of second fixing clips which are arranged to allow movement of the second fixing clips in relation of the guide rail in the vertical direction.

The technical effect of the invention is that it enables the total guide rail line movement resistance in the vertical direction to be altered and adjusted to a desired level. In other words, by selecting an appropriate mix of first fixing clips and second fixing clips the combined movement resistance of the entire guide rail line can be set to such that the mass of the guide rails is barely carried by the fixing elements but the building shrinkage caused translation movement of the guide rail line is allowed to pass through the fixing elements without causing significant loading on the guide rails themselves.

The pairs of the first fixing clips and the second fixing clips may be arranged along the length of the guide rail irregularly or at regular intervals. Any combination and order of the first fixing clips and the second fixing clips is possible. The contact between the guide rail and the second fixing clip may be a sliding contact or a rolling contact.

In an embodiment of the invention, along a length of the guide rail each nth pair of fixing clips is a pair of second fixing clips, wherein n is an integer number greater than 1.

In an embodiment of the invention, the pairs of the second fixing clips are arranged at least at an area along the guide rail wherein the shrinkage amount of the elevator shaft wall is at its greatest.

In an embodiment of the invention, the frictional holding force exerted to the guide rail by the second fixing clip is adjustable.

In an embodiment of the invention, the second fixing clip comprises a rolling member rotationally supported to the second arm and arranged to a rolling contact with the foot flange of the guide rail.

In an embodiment of the invention, the rolling member is a ball and the outer surface of the ball is in a rolling contact with the foot flange of the guide rail.

In an embodiment of the invention, the rolling member is a roller and the outer periphery of the roller is in a rolling contact with the foot flange of the guide rail.

In an embodiment of the invention, the second arm comprises a stationary shaft and the roller is a cylindrical sleeve arranged to rotate on the shaft.

In an embodiment of the invention, the roller has a rolling resistance which is adjustable by selection of the fit between the sleeve and the shaft for adjusting the frictional holding force exerted to the guide rail by the second fixing clip.

In an embodiment of the invention, the fit between the sleeve and the shaft is a sliding fit allowing free running of the sleeve, or a tight sliding fit allowing running controlled by the tightness of the fit.

In an embodiment of the invention, the second fixing clip comprises two or more rolling members arranged sequentially on the second arm.

In an embodiment of the invention, the elevator guide rail mounting arrangement comprises spacer elements arranged between the support brackets and the guide rail.

In an embodiment of the invention, the spacer elements comprise first spacer elements, the first spacer elements having an abutment surface against the foot flange of the guide rail at an opposite side of the foot flange in relation to the fixing clip.

In an embodiment of the invention, the first spacer element is attached to the same support bracket as the first fixing clips.

In an embodiment of the invention, the first spacer element is attached to the same support bracket as the second fixing clips.

In an embodiment of the invention, the spacer elements comprise second spacer elements, the second spacer elements having rolling elements having rolling peripheries in a rolling contact with the foot flange of the guide rail at an opposite side of the foot flange in relation to the fixing clips.

In an embodiment of the invention, the second spacer element is attached to the same support bracket as the first fixing clips.

In an embodiment of the invention, the second spacer element is attached to the same support bracket as the second fixing clips.

In an embodiment of the invention, the pressing force of the fixing clip against the foot flange is adjustable for adjusting the frictional holding force.

According to a second aspect, the present invention provides a method for mounting an elevator guide rail using the elevator guide rail mounting arrangement according to the first aspect. According to the invention the method comprises a step of mounting the guide rail to the support brackets mounted on the shaft wall by pairs of first fixing clips and by at least a pair of the second fixing clips, the number and relative positions of the pairs of first and second fixing clips being selected on the basis of shrinkage amount of the shaft wall.

A third aspect of the invention is a machine-room-less elevator system having a hoisting motor attached to the upper end of a guide rail within the elevator shaft. The machine-room-less elevator system comprises the elevator guide rail mounting arrangement according the first aspect of the invention.

A third aspect of the invention is an elevator system having a hoisting motor arranged to a machine room which is separate from the elevator shaft. The elevator system comprises an elevator guide rail mounting arrangement according to the first aspect of the invention.

In an embodiment of the second and/or the third aspect of the invention, the guide rail is supported to the shaft wall without being supported to the bottom of the elevator shaft.

In an embodiment of the second and/or the third aspect of the invention, the guide rail is supported to the shaft wall and to the bottom of the elevator shaft.

In an embodiment of the second and/or the third aspect of the invention, the guide rail is supported to the bottom of the elevator shaft via a screw jack and/or via an energy absorber.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows an axonometric view of a lower part of an elevator shaft having an elevator guide rail mounting arrangement according to one embodiment of the invention,

FIG. 2 is a schematic cross-section of the guide rail mounting arrangement with first fixing clips and a first spacer element which provide frictional holding force to resist the movement of the first fixing clips and the first spacer element in relation to the guide rail in vertical direction,

FIG. 3 is a further schematic cross-section of the guide rail mounting arrangement comprising second fixing clips and a second spacer element which allow movement of the second fixing clips and the second spacer element in relation of the guide rail in the vertical direction,

FIG. 4 is a further schematic cross-section of the guide rail mounting arrangement comprising first fixing clips and a second spacer element which in a restrained manner allow movement of the second fixing clips and the first spacer element in relation of the guide rail in the vertical direction,

FIG. 4 is a further schematic cross-section of the guide rail mounting arrangement comprising second fixing clips and a first spacer element which in a restrained manner allow movement of the second fixing clips and the first spacer element in a restrained manner in relation of the guide rail in the vertical direction,

FIG. 5 is a further schematic cross-section of the guide rail mounting arrangement comprising second fixing clips and a first spacer element which in a restrained manner allow movement of the second fixing clips and the first spacer element in a restrained manner in relation of the guide rail in the vertical direction,

FIG. 6 is a further schematic cross-section of the guide rail mounting arrangement comprising second fixing clips and a support bracket having rolling elements which allow movement of the second fixing clips and the support bracket in a restrained manner in relation of the guide rail in the vertical direction,

FIG. 7 is a further schematic partial cross-section of the guide rail mounting arrangement comprising a second fixing clip having a ball as a rolling member and a second spacer element having a ball as a rolling element which allow movement of the second fixing clips and the support bracket in a restrained manner in relation of the guide rail in the vertical direction,

FIG. 8 is an axonometric view of a second fixing clip having two rolling members,

FIG. 9 is an axonometric view of a second spacer element having four rolling elements,

FIG. 10 is a schematic illustration of a machine-roomless elevator system comprising a guide rail mounting arrangement according to one embodiment of the invention, and

FIG. 11 is a schematic illustration of an elevator system having a machine room and comprising a guide rail mounting arrangement according to one embodiment of the invention.

### DETAILED DESCRIPTION OF THE INVENTION

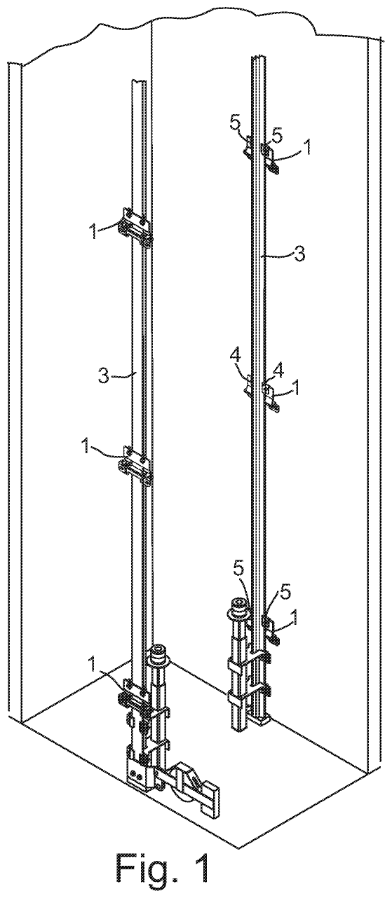

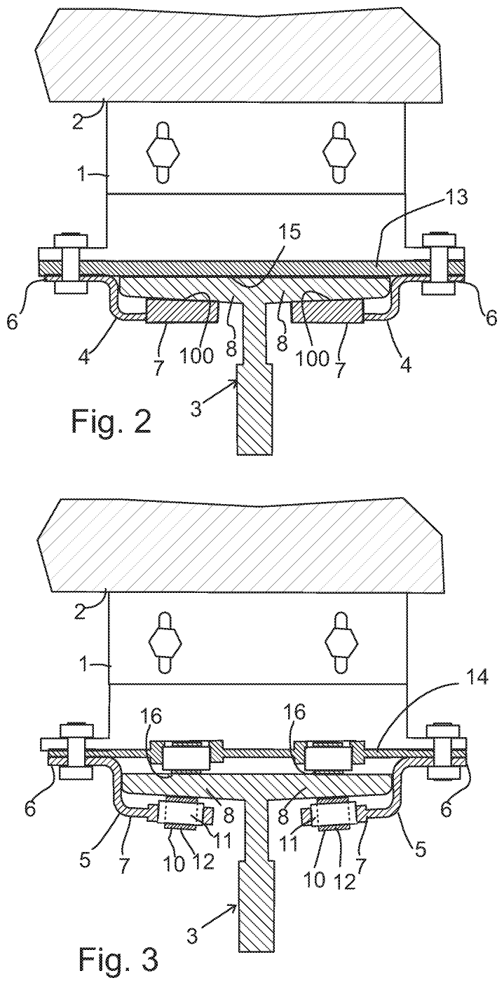

FIGS. 1, 10 and 11 schematically show an elevator guide rail mounting arrangement. Reference is also made to FIGS. 2 to 7. The elevator guide rail mounting arrangement comprises a plurality of support brackets 1 fixed to an elevator shaft wall 2. The support brackets 1 are spaced from each other vertically along the length of a guide rail 3. A pair of spring-like fixing clips 4, 5 is attached to each of the support brackets 1 for supporting the guide rail 3. The fixing clips 4, 5 prevent movement of the guide rail 3 in lateral direction. The fixing clips of each pair of fixing clips are arranged laterally on both sides of the guide rail 3. Each fixing clip 4, 5 comprises a first arm 6 and a second arm 7. The first arm 6 is fixed to the support bracket 3 by a bolted joint. The second arm 7 bears and presses against a lateral foot flange 8 of the guide rail 3.

The elevator guide rail mounting arrangement comprises pairs of first fixing clips 4 which are arranged to provide a frictional holding force to resist the movement of the first fixing clips 4 in relation to the guide rail 3 in vertical direction.

The elevator guide rail mounting arrangement further comprises pairs of second fixing clips 5 which are arranged to allow movement of the second fixing clips 5 in relation of the guide rail 3 in the vertical direction. Such a movement may occur due to shrinkage of the building, and consequently shrinkage of the elevator shaft wall 2 whereto the support brackets 1 are mounted stationary.

For example, the pairs of the second fixing clips 5 may be arranged at least at an area along the guide rail 3 wherein the shrinkage amount of the shaft wall 2 is at its greatest. In a further example, along a length of the guide rail 3, each nth pair of fixing clips may be a pair of second fixing clips 5, wherein n is an integer number greater than 1.

FIG. 2 shows a cross-section of a guide rail line at a position. The support bracket 1 is mounted to the elevator shaft wall 2. The guide rail 3 is mounted to the support bracket 1 by a pair of first fixing clips 4. The second arm 7 of the first fixing clip 4 has a first abutment surface 100 pressed against the foot flange 8 to provide a frictional holding force for resisting of the movement in vertical direction. A first spacer element 13 is arranged between the support bracket 1 and the guide rail 3. The first spacer elements 13 has an abutment surface 15 pressed against the foot flange 8 of the guide rail 3 at an opposite side of the foot flange 8 in relation to the first fixing clips 4. This arrangement provides a high frictional holding force to resist the movement of the first fixing clips 4 in relation to the guide rail 3 in vertical direction.

FIG. 3 shows a cross-section of a guide rail line at another position. The support bracket 1 is mounted to the elevator shaft wall 2. The guide rail 3 is mounted to the support bracket 1 by a pair of second fixing clips 5 having rolling members 10 pressed against the foot flange 8 of the guide rail 3. A second spacer element 14 is arranged between the support bracket 1 and the guide rail 3. The second spacer element 14 has rolling elements 16. The rolling elements 16 have rolling peripheries in a rolling contact with the foot flange 8 of the guide rail 3 at an opposite side of the foot flange in relation to the second fixing clips 5. This arrangement allows movement of the second fixing clips 5 and the second spacer element 14 in relation to the guide rail 3 in the vertical direction. The second fixing clips 5 and the second spacer element 14 may run on the foot flange 8 of the guide rail 3 as the support bracket 1 moves in vertical direction in relation to the guide rail 3.

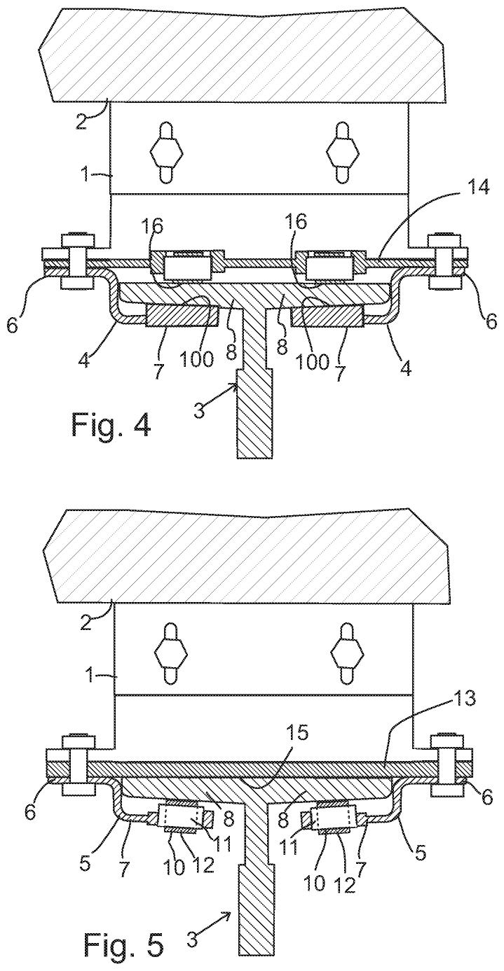

FIG. 4 shows a cross-section of a guide rail line at still another position. The support bracket 1 is mounted to the elevator shaft wall 2. The guide rail 3 is mounted to the support bracket 1 by a pair of first fixing clips 4. The second arm 7 of the first fixing clip 4 has a first abutment surface 100 pressed against the foot flange 8 to provide a frictional holding force for resisting of the movement in vertical direction. A second spacer element 14 is arranged between the support bracket 1 and the guide rail 3. The second spacer element 14 has rolling elements 16. The rolling elements 16 have rolling peripheries in a rolling contact with the foot flange 8 of the guide rail 3 at an opposite side of the foot flange in relation to the first fixing clips 4. This arrangement allows movement of the first fixing clips 4 and the second spacer element 14 in relation to the guide rail 3 in the vertical direction, but the resistance against the movement is greater than in the mounting shown in FIG. 3. This is because the first fixing clips 4 exert a resisting frictional force while the second spacer element 14 allows a more free movement.

FIG. 5 shows a cross-section of a guide rail line at still another position. The support bracket 1 is mounted to the elevator shaft wall 2. The guide rail 3 is mounted to the support bracket 1 by a pair of second fixing clips 5 having rolling members 10 pressed against the foot flange 8 of the guide rail 3. A first spacer element 13 is arranged between the support bracket 1 and the guide rail 3. The first spacer elements 13 has an abutment surface 15 pressed against the foot flange 8 of the guide rail 3 at an opposite side of the foot flange 8 in relation to the first fixing clips 4. This arrangement allows movement of the second fixing clips 5 in relation to the guide rail 3 in the vertical direction, but the resistance against the movement is greater than in the mounting shown in FIG. 3. This is because the first spacer element 13 exerts a resisting frictional force while the second fixing clips 5 allow a more free movement.

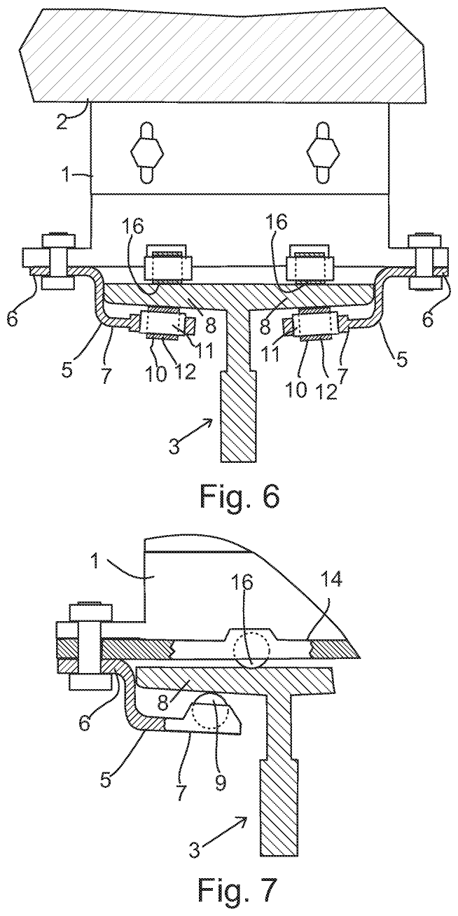

FIG. 6 shows an alternative embodiment to the embodiment of FIG. 3. In this embodiment the support bracket 1 is mounted to the elevator shaft wall 2. The guide rail 3 is mounted to the support bracket 1 by a pair of second fixing clips 5 having rolling members 10 pressed against the foot flange 8 of the guide rail 3. In this embodiment, there is no spacer element between the support bracket 1 and the guide rail 3. The rolling elements 16 are arranged in the structure of the support bracket 1. The rolling elements 16 of the support bracket 1 have rolling peripheries in a rolling contact with the foot flange 8 of the guide rail 3 at an opposite side of the foot flange in relation to the second fixing clips 5. Similarly as in FIG. 3, this arrangement allows movement of the second fixing clips 5 and support bracket 1 in relation to the guide rail 3 in the vertical direction. The second fixing clips 5 and the support bracket 1 may run on the foot flange 8 of the guide rail 3 as the support bracket 1 moves in vertical direction in relation to the guide rail 3.

The second fixing clip 5 comprises a rolling member 9, 10 rotationally supported to the second arm 7 and arranged to a rolling contact with the foot flange 8 of the guide rail.

FIG. 7 illustrates that the rolling member of the second fixing clip 5 may be a ball 9 and the outer surface of the ball 9 is in a rolling contact with the foot flange 8 of the guide rail 3. Similarly the rolling element 16 of the second spacer element 14 may be a ball. In a further not-shown embodiment, like in the embodiment of FIG. 6, the rolling element 16 mounted directly to the support bracket 1 may be a ball.

FIGS. 3, 5, 6 and 8 illustrate that the rolling member of the second fixing clip may be a roller 10. The outer periphery of the roller 10 is in a rolling contact with the foot flange 8 of the guide rail 3. The second arm 7 comprises a stationary shaft 11 and the roller 10 is a cylindrical sleeve 12 arranged to rotate on the shaft.

The frictional holding force exerted to the guide rail 3 by the second fixing clip 5 may be adjustable. The roller 10 may have a rolling resistance which is adjustable by selection of the fit between the sleeve 12 and the shaft 11 for adjusting the frictional holding force exerted to the guide rail 3 by the second fixing clip 5. The fit between the sleeve 12 and the shaft 11 may be a sliding fit allowing free running of the sleeve, or a tight sliding fit allowing running controlled by the tightness of the fit.

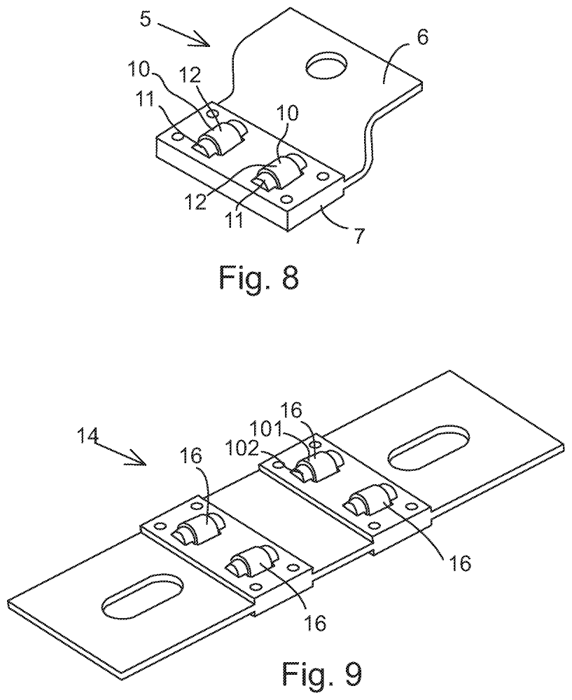

The second fixing clip 5 may comprise one or more rolling members, such as rollers 10 or balls 9, arranged sequentially on the second arm 7. FIG. 8 shows an embodiment having two rollers 10. The roller 10 comprises a cylindrical sleeve 12 arranged to rotate on a stationary shaft 11.

FIG. 9 shows an embodiment of the second spacer element 14 having four rolling elements 16. The rolling element 16 comprises a cylindrical sleeve 101 arranged to rotate on a stationary shaft 102.

In the Figures there are shown rolling members 10 and/or rolling elements 16 implemented as cylindrical sleeves 12, 101, rotating around a shaft 11, 102. It is possible to use ball-type rollers as rolling members 12 of the second fixing clip 5, and/or as rolling elements 16 of the second spacer element 14, and/or as rolling elements 16 of the support bracket 1. It is further also possible to use needle bearing-type rollers (not-shown) as rolling members 12 of the second fixing clip 5, and/or as rolling elements 16 of the second spacer element 14, and/or as rolling elements 16 of the support bracket 1. Further, the rolling member 10 and/or the rolling element 16 may comprise elastic material, such as polyurethane.

The pressing force of the fixing clip 4, 5 against the foot flange 8 may also adjustable for adjusting the frictional holding force. This may be implemented by adjusting the pressing force exerted to the foot flange from the fixing clips 4, 5 by shimming with shim elements, such as spacers.

Any combination of the guide rail mountings shown in FIGS. 2 to 9 can be used in a guide rail mounting arrangement of the invention. It is also possible to use merely the mounting arrangements of FIGS. 3 and/or 6, if the rolling resistance of the rolling members 10 and rolling elements 16 is to be arranged adjustable.

There are many different loading conditions that also affect the proper selection of the appropriate guide rail mounting arrangement. The elevator system may be a machine-room-less elevator system wherein the hoisting motor is attached to the guide rail and its weight must be taken into account, or an elevator system having a separate machine room. The guide rail may be supported to the shaft wall, thereby hanging on the shaft wall without being supported to the bottom of the elevator shaft. The guide rail may be supported to both the shaft wall and to the bottom of the elevator shaft. The support structure of the guide rail must also withstand the forces caused by safety gripping whereby also the weight of the car and passengers must be taken into account.

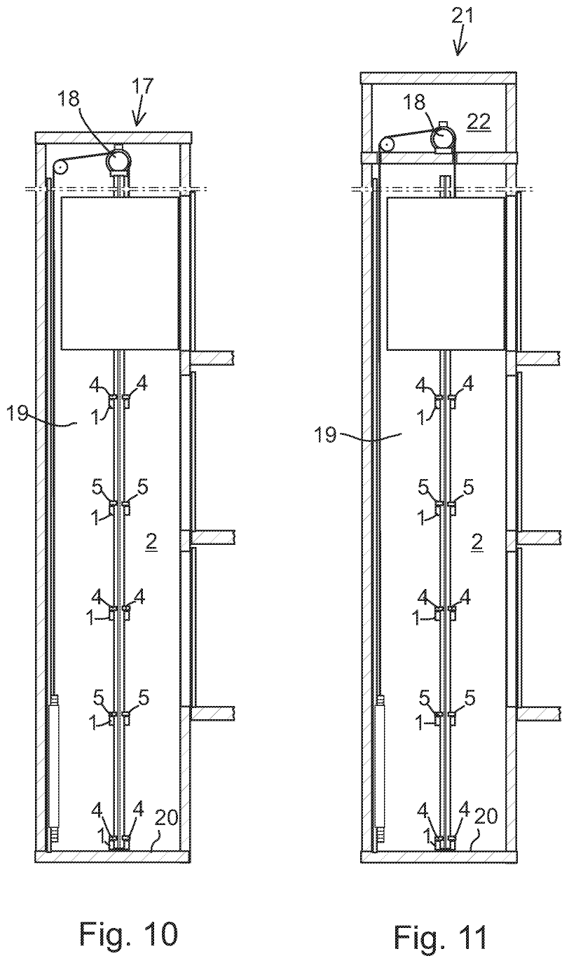

FIG. 10 shows a machine-room-less elevator system 17 having a hoisting motor 18 attached to the upper end of a guide rail 3 within the elevator shaft 19. The machine-room-less elevator system 17 comprises the elevator guide rail mounting arrangement according to the invention as described with reference to FIGS. 1 to 9 having a suitable combination of first and second fixing clips and first and second spacer elements. The guide rail 3 may be supported to the shaft wall 2 without being supported to the bottom 20 of the elevator shaft 18. Alternatively, the guide rail 3 may supported to the shaft wall 2 and to the bottom 20 of the elevator shaft 19. The guide rail 3 may be supported to the bottom 20 of the elevator shaft 19 via a screw jack and/or via an energy absorber.

FIG. 11 shows an elevator system 21 having a hoisting motor 18 arranged to a machine room 22 which is separate from the elevator shaft 19. The elevator guide rail mounting arrangement according to the invention as described with reference to FIGS. 1 to 9 having a suitable combination of first and second fixing clips and first and second spacer elements. The guide rail 3 may be supported to the shaft wall 2 without being supported to the bottom 20 of the elevator shaft 19. Alternatively, the guide rail 3 may be supported to the shaft wall 2 and to the bottom 20 of the elevator shaft 19. The guide rail 3 may be supported to the bottom 20 of the elevator shaft 19 via a screw jack and/or via an energy absorber.

In the method for mounting an elevator guide rail 3, the guide rail 3 is mounted to the support brackets 1 mounted on the shaft wall 2 by pairs of first fixing clips 4 and by pairs of the second fixing clips 5. The number and relative positions of the pairs of first and second fixing clips are selected on the basis of shrinkage amount of the shaft wall. The shrinkage amount can be measured or estimated by modelling or by calculations.

It is obvious to a person skilled in the art that with the advancement of technology, the basic idea of the invention may be implemented in various ways. The invention and its embodiment are thus not limited to the examples described above, but instead may vary within the scope of the claims.

1. An elevator guide rail mounting arrangement comprising
a plurality of support brackets fixed to an elevator shaft wall, the support brackets being spaced from each other vertically along the length of a guide rail, and
a pair of spring-like fixing clips attached to each of the support brackets for supporting the guide rail to prevent movement of the guide rail in lateral direction, the fixing clips of the pair being arranged on both sides of the guide rail, each fixing clip comprising a first arm being fixed to the support bracket and a second arm bearing and pressing against a lateral foot flange of the guide rail, and wherein the elevator guide rail mounting arrangement comprises pairs of first fixing clips which are arranged to provide a frictional holding force to resist the movement of the first fixing clips in relation to the guide rail in the vertical direction, wherein the elevator guide rail mounting arrangement comprises at least a pair of second fixing clips which are arranged to allow movement of the second fixing clips in relation of the guide rail in the vertical direction.

2. The elevator guide rail mounting arrangement according to claim 1, wherein along a length of the guide rail each nth pair of fixing clips is a pair of second fixing clips, wherein n is an integer number greater than 1.

3. The elevator guide rail mounting arrangement according to claim 1, wherein the pairs of the second fixing clips are arranged at least at an area along the guide rail wherein the shrinkage amount of the shaft wall is at its greatest.

4. The elevator guide rail mounting arrangement according to claim 1, wherein the frictional holding force exerted to the guide rail by the second fixing clip is adjustable.

5. The elevator guide rail mounting arrangement according to claim 1, wherein the second fixing clip comprises a rolling member rotationally supported to the second arm and arranged to a rolling contact with the foot flange of the guide rail.

6. The elevator guide rail mounting arrangement according to claim 5, wherein the rolling member is a ball and the outer surface of the ball is in a rolling contact with the foot flange of the guide rail.

7. The elevator guide rail mounting arrangement according to claim 5, wherein the rolling member is a roller and the outer periphery of the roller is in a rolling contact with the foot flange of the guide rail.

8. The elevator guide rail mounting arrangement according to claim 7, wherein the second arm comprises a stationary shaft and the roller is a cylindrical sleeve arranged to rotate on the shaft.

9. The elevator guide rail mounting arrangement according to claim 7, wherein the roller has a rolling resistance which is adjustable by selection of the fit between the sleeve and the shaft for adjusting the frictional holding force exerted to the guide rail by the second fixing clip.

10. The elevator guide rail mounting arrangement according to claim 9, wherein the fit between the sleeve and the shaft is a sliding fit allowing free running of the sleeve, or a tight sliding fit allowing running controlled by the tightness of the fit.

11. The elevator guide rail mounting arrangement according to claim 5, wherein the second fixing clip comprises two or more rolling members arranged sequentially on the second arm.

12. The elevator guide rail mounting arrangement according to claim 1, wherein the elevator guide rail mounting arrangement comprises spacer elements arranged between the support brackets and the guide rail.

13. The elevator guide rail mounting arrangement according to claim 12, wherein the spacer elements comprise first spacer elements, the first spacer elements having an abutment surface against the foot flange of the guide rail at an opposite side of the foot flange in relation to the fixing clip.

14. The elevator guide rail mounting arrangement according to claim 13, wherein the first spacer element is attached to the same support bracket as the first fixing clips.

15. The elevator guide rail mounting arrangement according to claim 13, wherein the first spacer element is attached to the same support bracket as the second fixing clips.

16. The elevator guide rail mounting arrangement according to claim 12, wherein the spacer elements comprise second spacer elements, the second spacer elements having rolling elements having rolling peripheries in a rolling contact with the foot flange of the guide rail at an opposite side of the foot flange in relation to the fixing clips.

17. The elevator guide rail mounting arrangement according to claim 16, wherein the second spacer element is attached to the same support bracket as the first fixing clips.

18. The elevator guide rail mounting arrangement according to claim 16, wherein the second spacer element is attached to the same support bracket as the second fixing clips.

19. The elevator guide rail mounting arrangement according to claim 1, wherein the pressing force of the fixing clip against the foot flange is adjustable for adjusting the frictional holding force.

20. A method for mounting an elevator guide rail using the elevator guide rail mounting arrangement according to claim 1, wherein the method comprises a step of mounting the guide rail to the support brackets mounted on the shaft wall by pairs of first fixing clips and by at least a pair of the second fixing clips, the number and relative positions of the pairs of first and second fixing clips being selected on the basis of shrinkage amount of the shaft wall.
